(19) United States
(12) Patent Application Publication
(10) Pub. No.: US 2012/0234635 A1
(43) Pub. Date: Sep. 20, 2012

(54) PIN SLIDE-TYPE FLOATING DISC BRAKE

(75) Inventors: Masaki WAKE, Miyoshi-shi (JP); Shohei Arakane, Kariya-shi (JP)

(73) Assignee: ADVICS CO., LTD., Kariya-shi (JP)

(21) Appl. No.: 13/420,041

(22) Filed: Mar. 14, 2012

(30) Foreign Application Priority Data
Mar. 15, 2011 (JP) 2011-056786

(51) Int. Cl. F16D 65/18; F16D 55/225

(52) U.S. Cl. 188/73.45

(57) ABSTRACT

A pin slide-type floating disc brake includes a mount, a caliper, one of which has a slide hole, a support pin provided to the other one and slidably inserted into the slide hole, and a tubular pin boot covering a part of the support pin. The pin boot includes a pin-side annular seal portion, a slide hole-side annular seal portion, and an extendable tubular bellows portion connecting those seal portions. The outer peripheral part of the slide hole-side annular seal portion includes an elastic restriction portion to elastically restrict movement of the slide hole-side annular seal portion in a rotor shaft direction, in an annular accommodation groove. The inner peripheral part of the slide hole-side annular seal portion includes, a first annular lip portion on a bellows portion side, and a second annular lip portion which has a retraction function on an opposite side to the bellows portion.

### CROSS REFERENCE TO RELATED APPLICATIONS

This application is based on and claims priority under 35 U.S.C. §119 to Japanese Patent Application 2010-241756, filed on Oct. 28, 2010, and Japanese Patent Application 2011-056786, filed on Mar. 15, 2011, the entire contents of which are incorporated herein by reference.

### BACKGROUND

1. Field of the Invention

The present invention relates to a pin slide-type floating disc brake for braking wheels of a vehicle.

2. Description of Related Art

There has been known a disc brake having the following configuration (refer to JP 2003-120725 A). Either one of a mount assembled to a vehicle body and a caliper assembled to be movable with respect to the mount in a rotor shaft direction is formed with a slide hole extending in the rotor shaft direction. A support pin is provided in the other thereof to extend in the rotor shaft direction and is slidably inserted into the slide hole. A part of the support pin protruding from the slide hole is covered with a tubular pin boot. The pin boot integrally includes a pin-side annular seal portion fitted to an outer periphery of the support pin, a slide hole-side annular seal portion fitted to an annular accommodation groove provided at an opening end portion of the slide hole, and having an outer peripheral part coming in pressure contact with a bottom wall surface of the annular accommodation groove and an inner peripheral part joined to an outer peripheral surface of the support pin, and an extendable tubular bellows portion connecting both the annular seal portions.

In the disc brake described in JP 2003-120725 A, in the inner peripheral part of the slide hole-side annular seal portion of the pin boot, an inner peripheral annular groove (annular notch) which opens to the outer peripheral surface of the support pin is formed at a middle portion in the rotor shaft direction, and a first annular lip portion which comes in sliding contact with the outer peripheral surface of the support pin to be movable in the rotor shaft direction, and a second annular lip portion which has a retraction function (a function of drawing back the support pin when braking is released) by being engaged with the outer peripheral surface of the support pin so as to be elastically deformable in the rotor shaft direction are formed on both sides of the inner peripheral annular groove.

In the meantime, in the disc brake described in JP 2003-120725 A, the second annular lip portion having the retraction function is provided at the opening end of the slide hole on the bellows portion side of the inner peripheral annular groove. Therefore, during the movement of the support pin with respect to the slide hole for braking, there is a concern that the second annular lip portion may be moved out of the slide hole and restriction (constriction) in the slide hole from the outer periphery may be released, and an engagement force (holding force) of the second annular lip portion on the support pin is reduced, so that a desired retraction function can not be obtained. In addition, since the outer peripheral part in the slide hole-side annular seal portion of the pin boot is accommodated in the annular accommodation groove so as to move a predetermined amount in the rotor shaft direction, assembility of the slide hole-side annular seal portion into the annular accommodation groove is improved. However, due to the slide hole-side annular seal portion moving in the annular accommodation groove in the rotor shaft direction, the retraction function may be degraded.

### SUMMARY

The present invention has been made in view of the above circumstances. According to an illustrative embodiment of the present invention, there is provided a pin slide-type floating disc brake comprising: a mount assembled to a vehicle body; a caliper assembled to be movable with respect to the mount in a rotor shaft direction, wherein either one of the mount and the caliper is formed with a slide hole extending in the rotor shaft direction; a support pin provided in the other one of the mount and the caliper to extend in the rotor shaft direction and slidably inserted into the slide hole; and a tubular pin boot covering a part of the support pin protruding from the slide hole. The pin boot integrally includes; a pin-side annular seal portion fitted to an outer periphery of the support pin; a slide hole-side annular seal portion fitted to an annular accommodation groove provided at an opening end portion of the slide hole, and including an outer peripheral part coming in pressure contact with a bottom wall surface of the annular accommodation groove and an inner peripheral part joined to an outer peripheral surface of the support pin; and an extendable tubular bellows portion connecting the pin-side annular seal portion and the slide hole-side annular seal portion. The outer peripheral part of the slide hole-side annular seal portion of the pin boot includes: an annular outer peripheral seal surface which comes in pressure contact with the bottom wall surface of the annular accommodation groove; and an elastic restriction portion which is elastically engaged with both side wall surfaces of the annular accommodation groove to elastically restrict movement of the slide hole-side annular seal portion in the rotor shaft direction, in the annular accommodation groove. The inner peripheral part of the slide hole-side annular seal portion of the pin boot includes: an inner peripheral annular groove which opens to the outer peripheral surface of the support pin at a middle portion thereof in the rotor shaft direction; a first annular lip portion which comes in sliding contact with the outer peripheral surface of the support pin to be movable in the rotor shaft direction on a bellows portion side of the inner peripheral annular groove; and a second annular lip portion which has a retraction function by being engaged with the outer peripheral surface of the support pin so as to be elastically deformable in the rotor shaft direction on an opposite side to the bellows portion of the inner peripheral annular groove.

According to the above configuration, the elastic restriction portion is formed in the outer peripheral part in the slide hole-side annular seal portion of the pin boot. Therefore, it is possible to elastically restrict the movement of the slide hole-side annular seal portion in the rotor shaft direction in the annular accommodation groove. Consequently, it is possible to suppress degradation in the retraction function caused by the movement of the slide hole-side annular seal portion in the rotor shaft direction, in the annular accommodation groove.

In addition, in the pin slide-type floating disc brake, since the second annular lip portion having the retraction function is formed on the opposite side to the bellows portion of the inner peripheral annular groove, the second annular lip portion is not moved outside the slide hole during movement of the support pin with respect to the slide hole for braking, and thus restriction (constriction) in the inner peripheral wall of the slide hole from the outer periphery is not released. Therefore, an engagement force (holding force) of the second annular lip portion on the support pin is maintained, so that a desired retraction function is obtained by the pin boot.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a side view illustrating a pin slide-type floating disc brake according an illustrative embodiment of the present invention;

FIG. 2 is a partially cutaway side view of FIG. 1;

FIG. 3 is a cross-sectional view taken along the line 3-3 of FIG. 1;

FIG. 4 is an enlarged cross-sectional view of an assembly part of a slide hole-side annular seal portion in a pin boot shown in FIG. 2;

FIG. 5 is a cross-sectional view of the pin boot shown in FIG. 4 in a free state;

FIG. 6 is a diagram of the pin boot shown in FIG. 5 while overlapping the pin boot shown in FIG. 4;

FIG. 7 is a cross-sectional view of a pin boot according to another illustrative embodiment in a free state; and

FIG. 8 is a cross-sectional view of a pin boot according to a further illustrative embodiment in a free state.

### DETAILED DESCRIPTION

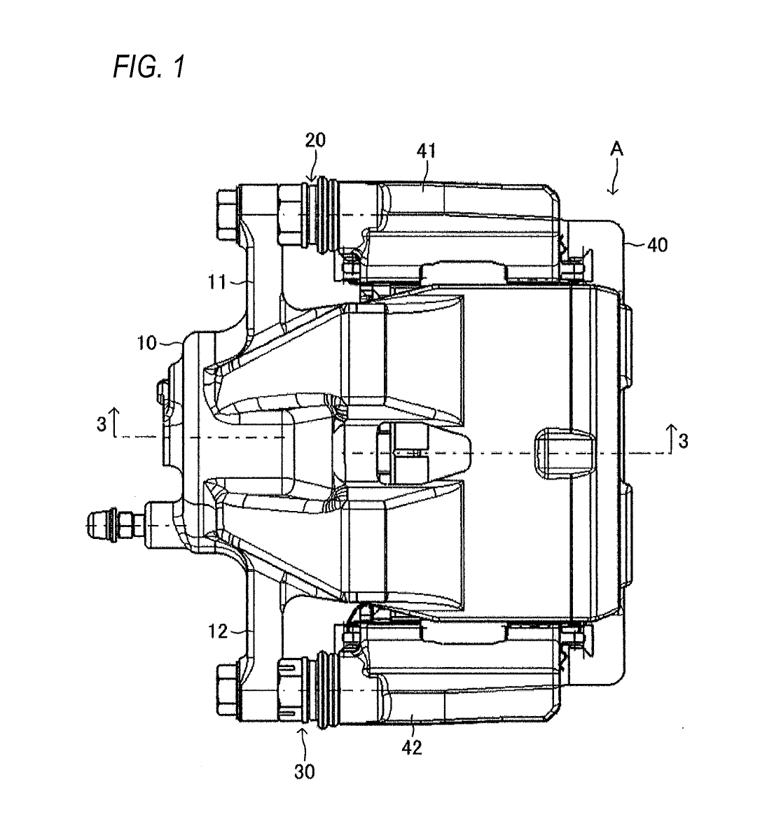

Hereinafter, illustrative embodiments of the present invention will be described with reference to the drawings. FIGS. 1 to 4 illustrate a pin slide-type floating disc brake for a vehicle according to an illustrative embodiment of the present invention. In the disc brake A of this illustrative embodiment, a caliper 10 is supported by both caliper support portions 41 and 42 of a mount 40 to be slidable in a rotor shaft direction via a pair of pin slide units 20 and 30 at both arm portions 11 and 12.

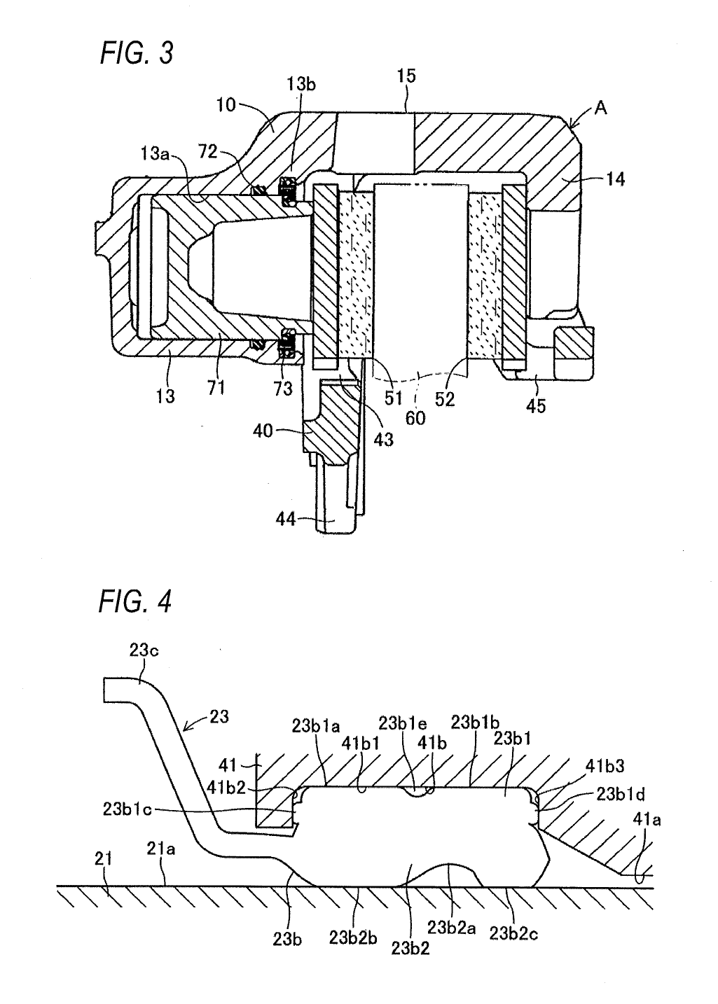

As illustrated in FIG. 3, the caliper 10 has a cylinder portion 13 which movably supports, in the rotor shaft direction, a piston 71 capable of moving to press an inner pad 51 against a disc rotor 60, a reaction portion 14 which is capable of moving to press an outer pad 52 against the disc rotor 60, and a bridge portion 15 connecting these portions while bridging a part of the disc rotor 60. A piston seal 72 and a dust boot 73 are provided between the cylinder portion 13 and the piston 71 of the caliper 10.

The piston seal 72 is assembled into a cylinder hole 13a of the cylinder portion 13 such that the inner peripheral portion thereof is engaged with the outer periphery of the piston 71, and the piston seal 72 and the piston 71 configure a piston retraction mechanism. The piston retraction mechanism has a function of retracting the piston 71 toward the inner side with respect to the cylinder portion 13 by a predetermined amount through an elastic restoring operation of the inner peripheral portion of the piston seal 72 when braking is released. The inner peripheral end portion of the dust boot 73 is assembled into the outer periphery of the piston 71, and the outer peripheral end portion thereof is assembled into an opening side mounting portion 13b of the cylinder hole 13a of the cylinder portion 13, thereby covering and protecting a sliding portion of the piston 71.

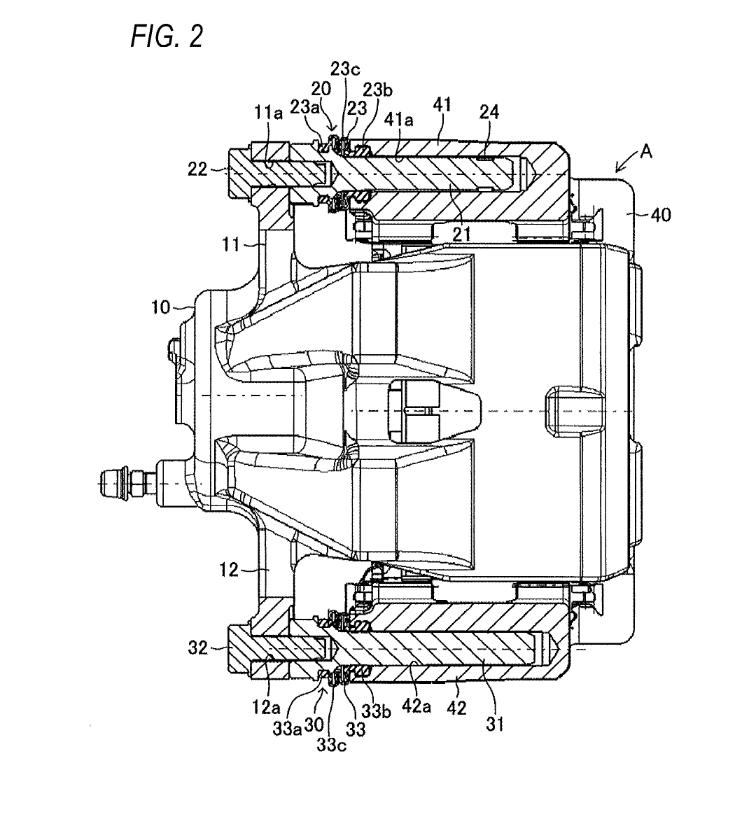

As illustrated in FIG. 2, one pin slide unit 20 includes a support pin 21 which extends in the rotor shaft direction and is inserted into a slide hole 41a provided in the caliper support portion 41 of the mount 40 to be slidable in the rotor shaft direction, a pin bolt 22 which is inserted into a mounting hole 11a provided in the arm portion 11 of the caliper 10 to connect the support pin 21 to the arm portion 11 of the caliper 10 integrally, a tubular pin boot 23 which is mounted to the outer periphery of a part of the support pin 21 protruding from the slide hole 41a to cover and protect a sliding portion of the support pin 21, and a bush 24 assembled to the tip end portion of the support pin 21.

As illustrated in FIG. 2, the other pin slide unit 30 includes a support pin 31 which extends in the rotor shaft direction and is inserted into a slide hole 42a provided in the caliper support portion 42 of the mount 40 to be slidable in the rotor shaft direction, a pin bolt 32 which is inserted into a mounting hole 12a provided in the arm portion 12 of the caliper 10 to connect the support pin 31 to the arm portion 12 of the caliper 10 integrally, and a tubular pin boot 33 which is mounted to the outer periphery of a part of the support pin 31 protruding from the slide hole 42a to cover and protect a sliding portion of the support pin 31.

The pin boots 23 and 33 are formed in the same shape, and integrally includes pin-side annular seal portions 23a and 33a fitted to the outer peripheries of the support pins 21 and 31, slide hole-side annular seal portions 23b and 33b fitted to annular accommodation grooves (see reference numeral 41b of FIG. 4) provided at the opening end portions of the slide holes 41a and 42a, and extendable tubular bellows portions 23c and 33c connecting both the annular seal portions. In each of the slide hole-side annular seal portions 23b and 33b, as illustrated in FIG. 4 exemplifying the pin boot 23 side, an outer peripheral part 23b1 comes in pressure contact with a bottom wall surface 41b1 of the annular accommodation groove 41b, and an inner peripheral portion 23b2 is joined to an outer peripheral surface 21a of the support pin 21.

The mount 40 has the above-mentioned caliper support portions 41 and 42, a pad support portion 43 and a mounting portion 44 on the inner side of the disc rotor 60, and a pad support portion 45 on the outer side of the disc rotor 60, and is formed in a shape bridging a part of the disc rotor 60. In addition, bolt insertion holes (not shown) are provided in the mounting portion 44, and thus the mount 40 is assembled into a part of a vehicle body by bolts (not shown) inserted to these holes.

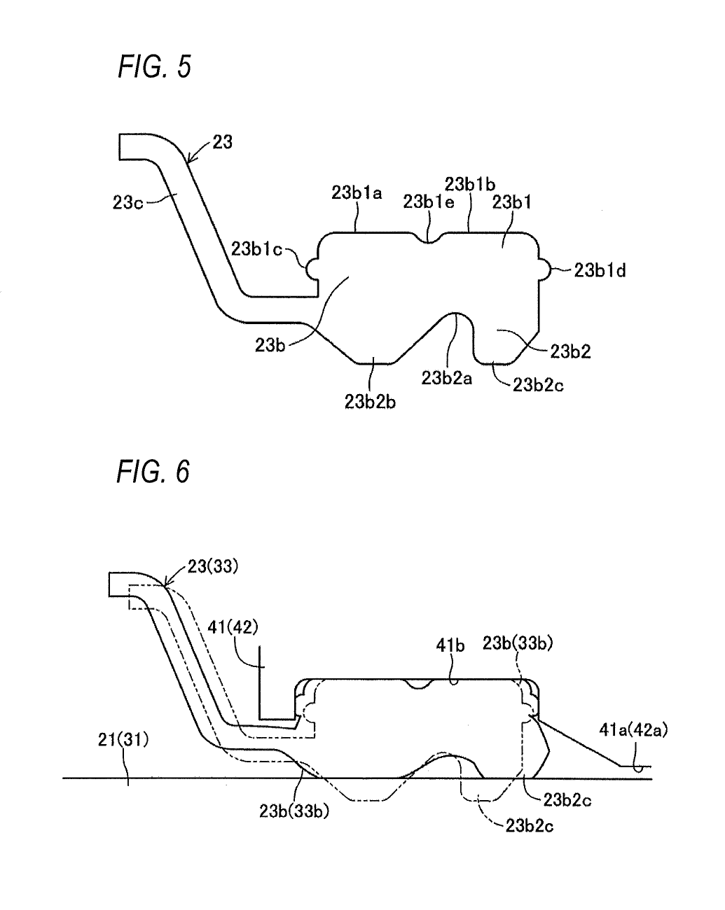

In the meantime, in this illustrative embodiment, as illustrated in FIGS. 4 and 5 exemplifying the pin boot 23 side, in the outer peripheral part 23b1 of the slide hole-side annular seal portion 23b of the pin boot 23, a pair of annular outer peripheral seal surfaces 23b1a and 23b1b which come in pressure contact with the bottom wall surface 41b1 of the annular accommodation groove 41b are formed. And, a first protrusion 23b1c and a second protrusion 23b1d as elastic restriction portions which are elastically engaged with both side wall surfaces 41b2 and 41b3 of the annular accommodation groove 41b to elastically restrict the movement of the slide hole-side annular seal portion 23b in the rotor shaft direction in the annular accommodation groove 41b are formed.

The annular outer peripheral seal surfaces 23b1a and 23b1b are halved in the rotor shaft direction by an annular concave portion 23b1e formed at the middle site of the outer peripheral part 23b1 in the rotor shaft direction. The annular concave portion 23b1e is open to the bottom wall surface 41b1 of the annular accommodation groove 41b. The first protrusion 23b1c protrudes in the rotor shaft direction from the middle part in the rotor diameter direction of the end surface on the bellows portion side of the outer peripheral portion 23b1 and is formed in an annular shape, and the tip end thereof is elastically engaged with and comes in pressure contact with the side wall surface 41b2 on the bellows portion side of the annular accommodation groove 41b. The second protrusion 23b1d protrudes in the rotor shaft direction from the middle part in the rotor diameter direction of the end surface on the opposite side to the bellows portion of the outer peripheral portion 23b1 and is formed in an annular shape, and the tip end thereof is elastically engaged with and comes in pressure contact with the side wall surface 41b3 on the opposite side to the bellows portion of the annular accommodation groove 41b. It is noted that the second protrusion 23b1d may not be formed in the annular shape.

In addition, in this illustrative embodiment, in the inner peripheral part 23b2 of the slide hole-side annular seal portion 23b of the pin boot 23, an inner peripheral annular groove 23b2a which opens to the outer peripheral surface 21a of the support pin 21 is formed at the middle portion in the rotor shaft direction, and a first annular lip portion 23b2b and a second annular lip portion 23b2c are formed on both sides of the inner peripheral annular groove 23b2a in the rotor shaft direction. The first annular lip portion 23b2b is formed on the bellows portion side of the inner peripheral annular groove 23b2a and comes in sliding contact with the outer peripheral surface 21a of the support pin 21 to be movable in the rotor shaft direction. The second annular lip portion 23b2c is formed on the opposite side to the bellows portion of the inner peripheral annular groove 23b2a and has a retraction function by being engaged with the outer peripheral surface 21a of the support pin 21 so as to be elastically deformable in the rotor shaft direction (a function of drawing back the support pin 21 through the elastic restoring operation when braking is released).

In addition, in this illustrative embodiment, on the opposite side to the bellows portion of the annular accommodation groove 41b, the end portion on the annular accommodation groove side of the slide hole 41a is formed in a tapered shape in which the end portion is reduced in diameter toward the slide hole side and is increased toward the annular accommodation groove side (see FIG. 4). In addition, as illustrated in FIGS. 4 and 5, the bellows portion side of the inner peripheral annular groove 23b2a is formed in a tapered shape in which the side thereof is reduced in diameter toward the bellows portion side and is increased in diameter toward the opposite side to the bellows portion.

In the disc brake A configured as described above, during braking, the inner pad 51 slides and is pressed against the disc rotor 60 by the piston 71, the outer pad 52 is moved to be pressed against the disc rotor 60 by the reaction portion 14 of the caliper 10, and the inner pad 51 and the outer pad 52 come in sliding contact with the disc rotor 60 for braking. In addition, when braking is released, the caliper 10 and the piston 71 are returned by the retraction function obtained by the pin boots 23 and 33 and the retraction function obtained by the piston seal 72, thereby releasing the braking.

However, in the disc brake A, the above-mentioned elastic restriction portions (the first and second protrusions 23b1c and 23b1d) are formed at the outer peripheral part 23b1 in the slide hole-slide annular seal portion 23b of the pin boots 23 and 33. Therefore, it is possible to elastically restrict the movement of the slide hole-side annular seal portion 23b in the rotor shaft direction in the annular accommodation groove 41b. Consequently, it is possible to suppress degradation in the retraction function (the retraction function obtained by the second annular lip portion 23b2c) caused by the movement of the slide hole-side annular seal portion 23b in the rotor shaft direction in the annular accommodation groove 41b.

In addition, in the disc brake A, since the second annular lip portion 23b2c having the function of retracting the pin boots 23 and 33 is formed on the opposite side to the bellows portion of the inner peripheral annular groove 23b2a, the second annular lip portion 23b2c is not moved outside the slide holes 41a and 42a during movement of the support pins 21 and 31 with respect to the slide holes 41a and 42a due to braking, and thus restriction (constriction) in the inner peripheral wall of the slide holes 41a and 42a from the outer periphery is not released. Therefore, an engagement force (holding force) of the second annular lip portion 23b2c on the support pins 21 and 31 is maintained, so that a desired retraction function is obtained by the pin boots 23 and 33.

In addition, in the disc brake A, the elastic restriction portions include the first protrusion 23b1c which protrudes in the rotor shaft direction from the middle part in the rotor diameter direction of the end surface on the bellows portion side of the outer peripheral part 23b1 and is elastically engaged with the side wall surface 41b2 on the bellows portion side of the annular accommodation groove 41b, and the second protrusion 23b1d which protrudes in the rotor shaft direction from the middle part in the rotor diameter direction of the end surface on the opposite side to the bellows portion of the outer peripheral part 23b1 and is elastically engaged with the side wall surface 41b3 on the opposite side to the bellows portion of the annular accommodation groove 41b. Therefore, compared to a case where a protruding portion is provided at each of the entire end surface on the bellows portion side of the outer peripheral part and the entire end surface on the opposite side to the bellows portion, it is possible to sufficiently ensure a space that facilitates assembly into the annular accommodation groove 41b, so that it is possible to achieve both good assembility of the slide hole-side annular seal portion 23b into the annular accommodation groove 41b and suppression of the degradation in the retraction function.

In addition, in the disc brake A, since the first protrusion (the protrusion 23b1c on the bellows portion side) is formed in the annular shape and the tip end thereof comes in pressure contact with the side wall surface 41b2 on the bellows portion side of the annular accommodation groove 41b, sealing properties (preventing infiltration of water or dust into the slide holes 41a and 42a) are obtained also by the first protrusion 23b1c coming in pressure contact with the side wall surface 41b2 on the bellows portion side of the annular accommodation groove 41b, and thus it is possible to improve the sealing properties.

In addition, in the disc brake A, at the middle site in the rotor shaft direction of the outer peripheral part 23b1 of the pin boots 23 and 33, the annular concave portion 23b1e is formed which is open to the bottom wall surface 41b1 of the annular accommodation grooves 41b and halves the annular outer peripheral seal surfaces 23b1a and 23b1b. Therefore, the surface pressure of the annular outer peripheral seal surfaces 23b1a and 23b1b against the bottom wall surface 41b1 of the annular accommodation groove 41b may be easily increased, and even though water or dust is infiltrated into the slide holes 41a and 42a along the outer peripheries of the pin boots 23 and 33, the water or dust may be always collected in the annular concave portion 23b1e, and thus it is possible to improve the sealing properties.

In addition, in the disc brake A, on the opposite side to the bellows portion of the annular accommodation groove 41b, the end portion on the annular accommodation groove side of the slide holes 41a and 42a is formed in the tapered shape in which the end portion is reduced in diameter toward the slide hole side and is increased toward the annular accommodation groove side, and the bellows portion side of the inner peripheral annular groove 23b2a is formed in the tapered shape in which the side is reduced in diameter toward the bellows portion side and is increased in diameter toward the opposite side to the bellows portion. Therefore, as illustrated in FIG. 6, the slide hole-side annular seal portions 23b and 33b of the pin boots 23 and 33 are elastically deformed from a state shown by the virtual line to a state shown by the solid line by being respectively assembled between the support pins 21 and 31 and the caliper support portions 41 and 42, and a space which allows bending of the second annular lip portion 23b2c on both sides in the rotor shaft direction of the second annular lip portion 23b2c having the function of retracting the pin boots 23 and 33 may be sufficiently ensured, so that it is possible to improve the retraction function by the second annular lip portion 23b2c.

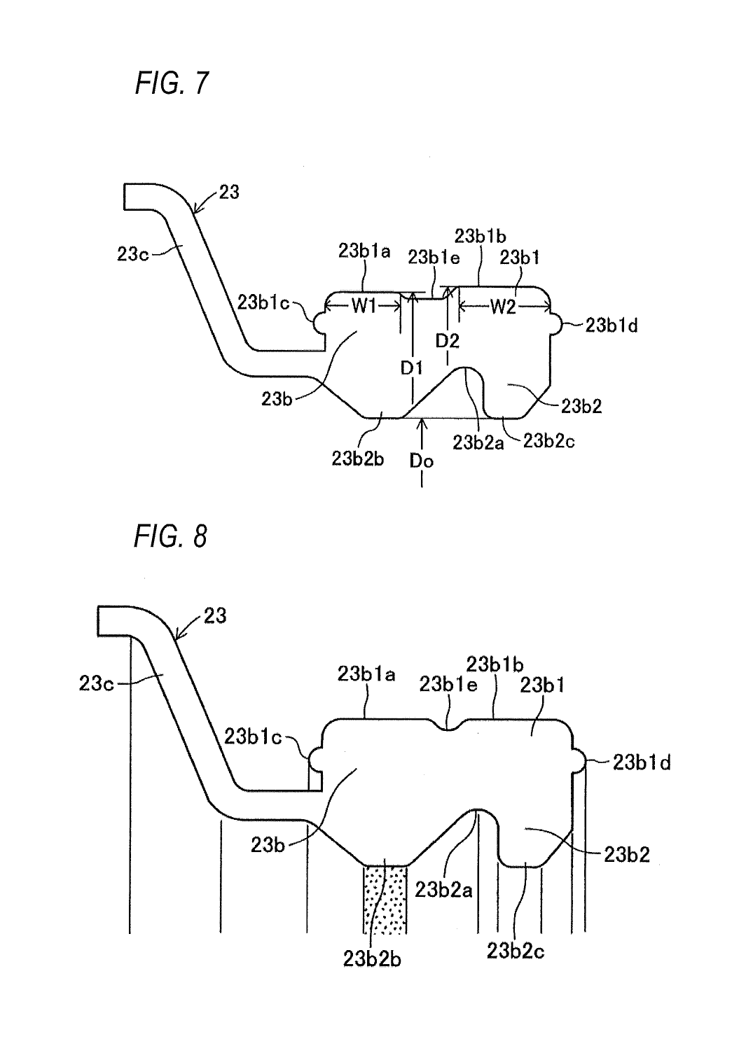

In the above-described illustrative embodiment, the outside diameter of the (first) annular outer peripheral seal surface 23b1a in a free state, which is halved by the annular concave portion 23b1e and is positioned on the outside diameter side of the first annular lip portion 23b2b, and the outside diameter of the (second) annular outer peripheral seal surface 23b1b in a free state, which is halved by the annular concave portion 23b1e and is positioned on the outside diameter side of the second annular lip portion 23b2c are equal to each other, and the inside diameter of the first annular lip portion in a free state and the inside diameter of the second annular lip portion in a free state are equal to each other. However, a modified configuration may also be possible as in an illustrative embodiment shown in FIG. 7.

In the illustrative embodiment shown in FIG. 7, the outside diameter D1 of the (first) annular outer peripheral seal surface 23b1a in the free state, which is halved by the annular concave portion 23b1e and is positioned on the outside diameter side of the first annular lip portion 23b2b is smaller than the outside diameter D2 of the (second) annular outer peripheral seal surface 23b1b in the free state, which is halved by the annular concave portion 23b1e and is positioned on the outside diameter side of the second annular lip portion 23b2c, and the inside diameter of the first annular lip portion 23b2b in the free state and the inside diameter of the second annular lip portion 23b2c in the free state are the same diameter Do.

Therefore, when the slide hole-side annular seal portion 23b of the pin boot 23 is fitted into the annular accommodation groove 41b, the constriction force (holding force) of the first annular lip portion 23b2b on the support pin 21 may be smaller than the constriction force (holding force) of the second annular lip portion 23b2c on the support pin 21. Therefore, the sliding resistance between the first annular lip portion 23b2b and the support pin 21 may be smaller than the sliding resistance between the second annular lip portion 23b2c and the support pin 21, so that it is possible to sufficiently achieve the retraction function by the second annular lip portion 23b2c.

In addition, in the illustrative embodiment shown in FIG. 7, the length W1 of the (first) annular outer peripheral seal surface 23b1a in the rotor shaft direction is smaller than the length W2 of the (second) annular outer peripheral seal surface 23b1b in the rotor shaft direction. Therefore, while the constriction force (holding force) of the first annular lip portion 23b2b on the support pin 21 is reduced, it is possible to maintain the surface pressure of the (first) annular outer peripheral seal surface 23b1a against the bottom wall surface 41b1 in the annular accommodation groove 41b (to be equal to the surface pressure of the (second) annular outer peripheral seal surface 23b1b against the bottom wall surface 41b1 in the annular accommodation groove 41b), so that it is possible to maintain waterproof properties by the (first) annular outer peripheral seal surface 23b1a while obtaining the above effects.

In addition, in the above illustrative embodiment, the configuration is employed in which the surface roughness of the sliding surface (inner peripheral surface) of the first annular lip portion 23b2b on the support pin 21 and the surface roughness of the sliding surface (inner peripheral surface) of the second annular lip portion 23b2c on the support pin 21 are equal to each other. However, a configuration may also be employed as in the illustrative embodiment shown in FIG. 8. In the illustrative embodiment shown in FIG. 8, the surface roughness of the sliding surface (inner peripheral surface) of the first annular lip portion 23b2b on the support pin 21 is greater than the surface roughness of the sliding surface (inner peripheral surface) of the second annular lip portion 23b2c on the support pin 21.

Accordingly, in a case where a grease (not shown) is provided between the slide hole-side annular seal portion 23b of the pin boot 23 and the support pin 21, the amount of the grease per unit area accommodated in the sliding surface of the first annular lip portion 23b2b on the support pin 21 would be greater than the amount of the grease per unit area accommodated in the sliding surface of the second annular lip portion 23b2c on the support pin 21. Therefore, the sliding resistance of the first annular lip portion 23b2b against the support pin 21 may be smaller than the sliding resistance of the second annular lip portion 23b2c against the support pin 21, so that it is possible to sufficiently achieve the retraction function by the second annular lip portion 23b2c.

In addition, the first protrusion 23b1c may be formed larger so as not to form a space between the first protrusion 23b1c and the annular accommodation groove 41b, i.e., so as to fill the space. In this case, the pressure contact between the first protrusion 23b1c and the annular accommodation groove 41b becomes stronger, so that sealing property can be further improved.

In addition, in each of the above illustrative embodiments, the present invention is embodied in the disc brake A in which the pin slide units 20 and 30 respectively include the support pins 21 and 31 which are integrally assembled to the caliper 10 and extend in the rotor shaft direction, and the slide holes 41a and 42a which are provided in the mount 40 and into which the support pins 21 and 31 are inserted to be slidable in the rotor shaft direction. However, the present invention may be similarly embodied in a disc brake in which pin slide units respectively have support pints which are integrally assembled to a mount and extend in a rotor shaft direction, and slide holes which are provided in a caliper and into which the support pins are inserted to be slidable in the rotor shaft direction.

What is claimed is:

1. A pin slide-type floating disc brake comprising:
a mount assembled to a vehicle body;
a caliper assembled to be movable with respect to the mount in a rotor shaft direction, wherein either one of the mount and the caliper is formed with a slide hole extending in the rotor shaft direction;
a support pin provided in the other one of the mount and the caliper to extend in the rotor shaft direction and slidably inserted into the slide hole; and
a tubular pin boot covering a part of the support pin protruding from the slide hole,
wherein the pin boot integrally includes;
a pin-side annular seal portion fitted to an outer periphery of the support pin;
a slide hole-side annular seal portion fitted to an annular accommodation groove provided at an opening end portion of the slide hole, and including an outer peripheral part coming in pressure contact with a bottom wall surface of the annular accommodation groove and an inner peripheral part joined to an outer peripheral surface of the support pin; and
an extendable tubular bellows portion connecting the pin-side annular seal portion and the slide hole-side annular seal portion,
wherein the outer peripheral part of the slide hole-side annular seal portion of the pin boot includes:
an annular outer peripheral seal surface which comes in pressure contact with the bottom wall surface of the annular accommodation groove; and
an elastic restriction portion which is elastically engaged with both side wall surfaces of the annular accommodation groove to elastically restrict movement of the slide hole-side annular seal portion in the rotor shaft direction, in the annular accommodation groove, and
wherein the inner peripheral part of the slide hole-side annular seal portion of the pin boot includes:
an inner peripheral annular groove which opens to the outer peripheral surface of the support pin at a middle portion thereof in the rotor shaft direction;
a first annular lip portion which comes in sliding contact with the outer peripheral surface of the support pin to be movable in the rotor shaft direction on a bellows portion side of the inner peripheral annular groove; and
a second annular lip portion which has a retraction function by being engaged with the outer peripheral surface of the support pin so as to be elastically deformable in the rotor shaft direction on an opposite side to the bellows portion of the inner peripheral annular groove.

2. The pin slide-type floating disc brake according to claim 1,
wherein the elastic restriction portion includes:
a first protrusion which protrudes in the rotor shaft direction from a middle part in a rotor diameter direction of an end surface of the outer peripheral part on the bellows portion side and which is elastically engaged with the side wall surface of the annular accommodation groove on the bellows portion side; and
a second protrusion which protrudes in the rotor shaft direction from a middle part in the rotor diameter direction of an end surface of the outer peripheral part on the opposite side to the bellows portion and which is elastically engaged with the side wall surface of the annular accommodation groove on the opposite side to the bellows portion.

3. The pin slide-type floating disc brake according to claim 2,
wherein the first protrusion is formed in an annular shape and has a tip end coming in pressure contact with the side wall surface of the annular accommodation groove on the bellows portion side.

4. The pin slide-type floating disc brake according to claim 1,
wherein the outer peripheral part is formed with an annular concave portion at a middle site in the rotor shaft direction, the concave portion being open to the bottom wall surface of the annular accommodation groove and halving the annular outer peripheral seal surface.

5. The pin slide-type floating disc brake according to claim 1,
wherein on the opposite side to the bellows portion of the annular accommodation groove, an end portion of the slide hole on an annular accommodation groove side is formed in a tapered shape to be reduced in diameter toward a slide hole side and increased in diameter toward the annular accommodation groove side, and
wherein the inner peripheral annular groove on a bellows portion side is formed in a tapered shape to be reduced in diameter toward the bellows portion side and increased in diameter toward the opposite side to the bellows portion.

6. The pin slide-type floating disc brake according to claim 4,
wherein an outside diameter of a first annular outer peripheral seal surface in a free state, which is halved by the annular concave portion and is positioned on an outside diameter side of the first annular lip portion is smaller than an outside diameter of a second annular outer peripheral seal surface in a free state, which is halved by the annular concave portion and is positioned on an outside diameter side of the second annular lip portion, and
wherein an inside diameter of the first annular rip portion in a free state is same as an inside diameter of the second annular lip portion in a free state.

7. The pin slide-type floating disc brake according to claim 6,
wherein a length of the first annular outer peripheral seal surface in the rotor shaft direction is smaller than a length of the second annular outer peripheral seal surface in the rotor shaft direction.

8. The pin slide-type floating disc brake according to claim 1,
wherein a grease is provided between the slide hole-side annular seal portion of the pin boot and the support pin, and
wherein a surface roughness of a sliding surface of the first annular lip portion on the support pin is greater than a sliding surface of the second annular lip portion on the support pin.
